(19) United States
(12) Patent Application Publication
(10) Pub. No.: US 2023/0259795 A1
(43) Pub. Date: Aug. 17, 2023

(54) MONITORING SYSTEM, MONITORING METHOD, AND COMPUTER-READABLE RECORDING MEDIUM STORING MONITORING PROGRAM

(71) Applicant: Fujitsu Limited, Kawasaki-shi (JP)

(72) Inventors: YUTA SHIMODA, Kobe (JP); Shoichi Kogiso, Nagoya (JP); Masahiro FUKUDA, Nagoya (JP); Yuki Umezawa, Nagoya (JP); Naoya Hirota, Nagoya (JP); Toru Kitayama, Kobe (JP); Tomoaki Shiozawa, Kobe (JP); Ryota Kanaya, Suginami (JP)

(73) Assignee: Fujitsu Limited, Kawasaki-shi (JP)

(21) Appl. No.: 17/983,428

(22) Filed: Nov. 9, 2022

(30) Foreign Application Priority Data
Feb. 16, 2022 (JP) 2022-022280

(51) Int. Cl. G06N 5/04; G06F 11/07

(52) U.S. Cl. CPC G06N 5/04; G06F 11/0769; G06F 11/0721

(57) ABSTRACT

A recording medium stores a monitoring program that cause a computer to execute processes including: determining a learning range, used in learning of messages, for each of monitoring target systems based on time-series information of each of past message groups and on keyword information that suggests a forwarding destination; generating a learning model, used to infer information on the forwarding destination, by using the determined learning range as a parameter and by using the time-series information, the information on the forwarding destination, and the keyword information included in each of the messages in the case where the message is the error message as training data; and selecting the learning model to be applied to the new system based on a degree of similarity between the keyword information used in the learning of each of the monitoring target systems and the keyword information of the error message of the new system.

### CROSS-REFERENCE TO RELATED APPLICATION

This application is based upon and claims the benefit of priority of the prior Japanese Patent Application No. 2022-22280, filed on Feb. 16, 2022, the entire contents of which are incorporated herein by reference.

### FIELD

The embodiment discussed herein is related to a computer-readable recording medium storing a monitoring program and the like.

### BACKGROUND

In system monitoring, a person in charge of operation checks many messages occurring from multiple systems. When an error message occurs, the person in charge of operation has to determine a forwarding destination to which the error message is to be forwarded for primary response.

Japanese Laid-open Patent Publication No. 2017-004097 and International Publication Pamphlet Nos. WO 2014/103071 and WO 2016/132717 are disclosed as related art.

### SUMMARY

According to an aspect of the embodiments, a non-transitory computer-readable recording medium stores a monitoring program that cause a computer to execute processes including: determining a learning range, used in learning of messages, for each of monitoring target systems based on time-series information of each of past message groups and on keyword information that is obtained from contents of each of the messages and that suggests a forwarding destination of the message; generating a learning model, used to infer information on the forwarding destination from the keyword information of an error message, for each of the monitoring target systems by using the determined learning range as a parameter and by using the time-series information, the information on the forwarding destination, and the keyword information included in each of the messages in the case where the message is the error message as training data; and when the error message of a new system is obtained, selecting the learning model to be applied to the new system from the learning models of the monitoring target systems, based on a degree of similarity between the keyword information used in the learning of each of the monitoring target systems and the keyword information of the error message of the new system.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is a functional block diagram illustrating a configuration of a monitoring system according to an embodiment;

FIG. 2A is a diagram (1) illustrating an example of a flow of learning processing according to the embodiment;

FIG. 2B is a diagram (2) illustrating an example of the flow of learning processing according to the embodiment;

FIG. 3A is a diagram (1) illustrating an example of a flow of inference processing according to the embodiment;

FIG. 3B is a diagram (2) illustrating an example of the flow of inference processing according to the embodiment;

FIG. 4 is a diagram illustrating an example of past message data;

FIG. 5 is a diagram illustrating an example of keyword data;

FIG. 6 is a diagram illustrating an example of non-keyword data;

FIG. 7 is a diagram illustrating an example of keyword vector data;

FIG. 8 is a diagram illustrating an example of learning range determination according to the embodiment;

FIG. 9 is a diagram illustrating an example of the past message data in which keywords are vectorized;

FIG. 10 is a diagram illustrating an example of a forwarding destination inference model determination result according to the embodiment;

FIG. 11 is a diagram illustrating an example of a forwarding destination inference result according to the embodiment;

FIG. 12 is a diagram illustrating an example of a flowchart of an entire monitoring system according to the embodiment;

FIG. 13 is a diagram illustrating an example of a flowchart of the learning processing according to the embodiment;

FIG. 14 is a diagram illustrating an example of a flowchart of the learning range determination processing according to the embodiment;

FIGS. 15A and 15B are a diagram illustrating an example of a flowchart of the inference processing according to the embodiment; and

FIG. 16 is a diagram illustrating an example of a computer that executes a monitoring program.

### DESCRIPTION OF EMBODIMENTS

When an error occurs in a certain system, in many cases, the error does not occur only in this system and related errors also occur in other systems. Accordingly, the person in charge of operation has to respond to multiple error messages for one error, and the response load increases.

A technique related to a response to an error message is disclosed. For example, a first technique discloses a technique of presenting strongly-related information to a user as an analysis result together with a basis, for information on logs and alerts.

A second technique discloses the following technique. One or more existing systems having a predetermined degree of similarity to a new system that is newly created or whose configuration is changed are extracted based on a degree of similarity between the system configuration of each of multiple existing systems and the system configuration of the new system, and a candidate for a method of response to an event for the new system is created by using methods of response to events for the extracted existing systems.

A third technique discloses the following technique. In analysis of a log message group, a structural pattern of the log message group is analyzed by being compared with known (normal and abnormal) patterns, and is associated with reference information including information on the known pattern matching a structural pattern of another log message group accompanying the log message group.

However, the related art has a problem that it is difficult to reduce load of error message response performed by the person in charge of operation.

For example, in the first technique, the strongly-related information is presented to the user as the analysis result for the information on the error message. However, the first technique is not a technique of analyzing the forwarding destination to which the error message is to be forwarded. Accordingly, it is difficult to reduce the load of error message response performed by the person in charge of operation.

In the second technique, the candidate for the method of response to the event in the new system is created based on the degree of similarity in configuration between the new system and each of the existing systems. However, even if the configurations of the systems are similar, the methods of responses to the error message may not be similar. Accordingly, it is difficult to reduce the load of error message response performed by the person in charge of operation.

In the third technique, in the analysis of the log message group, the information on the known pattern matching the structural pattern of another log message group accompanying the log message group is associated with the structural pattern of the log message group. However, this technique is also not a technique of analyzing the forwarding destination to which the log message group is to be forwarded. Accordingly, it is difficult to reduce the load of error message response performed by the person in charge of operation.

An object of one aspect of the present disclosure is to reduce load of error message response performed by the person in charge of operation.

Hereinafter, an embodiment of a monitoring system, a monitoring method, and a computer-readable recording medium storing a monitoring program disclosed in the present application will be described in detail based on the drawings. The present disclosure is not limited by the embodiment.

### Embodiment

### Configuration of Monitoring System

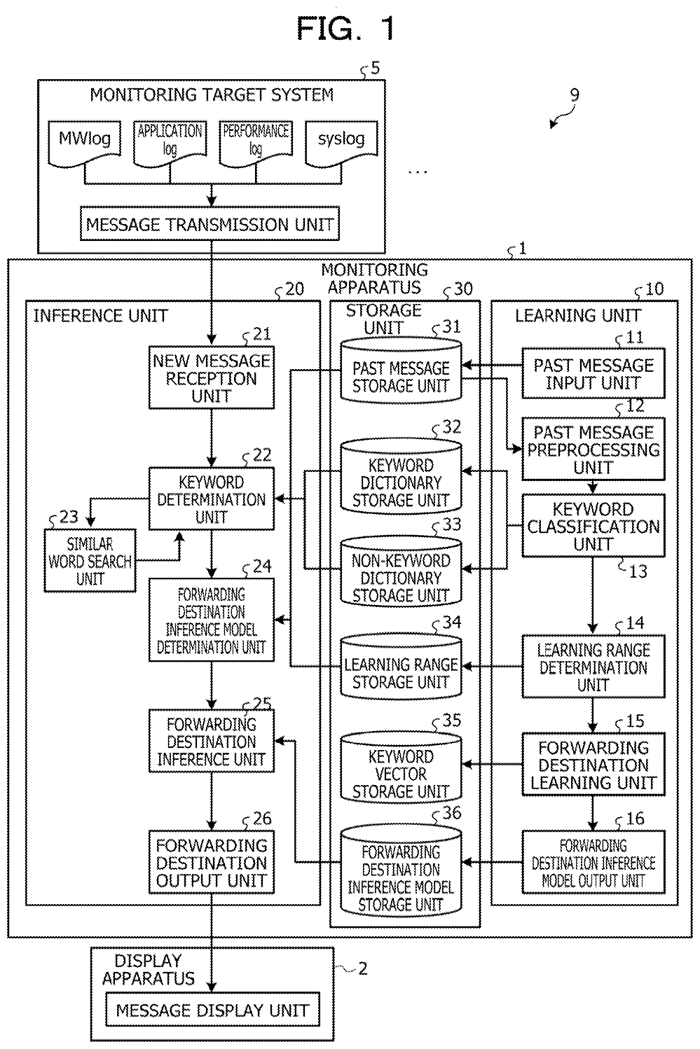

FIG. 1 is a functional block diagram illustrating a configuration of the monitoring system according to the embodiment. As illustrated in FIG. 1, the monitoring system 9 includes a monitoring apparatus 1, a display apparatus 2, and multiple monitoring target systems 5. The monitoring target systems 5 are each a system to be monitored. The monitoring apparatus 1 monitors the multiple monitoring target systems 5. For each monitoring target system 5, the monitoring apparatus 1 generates a primary response inference model. The primary response inference model is obtained by learning relationships between a past message group and primary responses in identification of causes of system errors while using a learning range. The learning range is a range in which messages are learned and varies among the monitoring target systems 5. The primary response herein includes a forwarding destination to which the message is to be forwarded. When a new monitoring target system 5 is added and the monitoring apparatus 1 receives a new message from the new monitoring target system 5, the monitoring apparatus 1 calculates a similarity between the received message and each of message groups used for the learning of the existing monitoring target systems 5, and selects the primary response inference model of the monitoring target system 5 with the highest similarity. The monitoring apparatus 1 applies the selected primary response inference model to the new message to infer a primary response for the received message. The primary response herein refers to a responder that is to primarily respond to the message (forwarding destination to which the message is to be forwarded), and examples thereof include a department. When the monitoring apparatus 1 receives a message from any of the existing monitoring target systems 5, the monitoring apparatus 1 applies the corresponding primary response inference model to the message to infer the primary response.

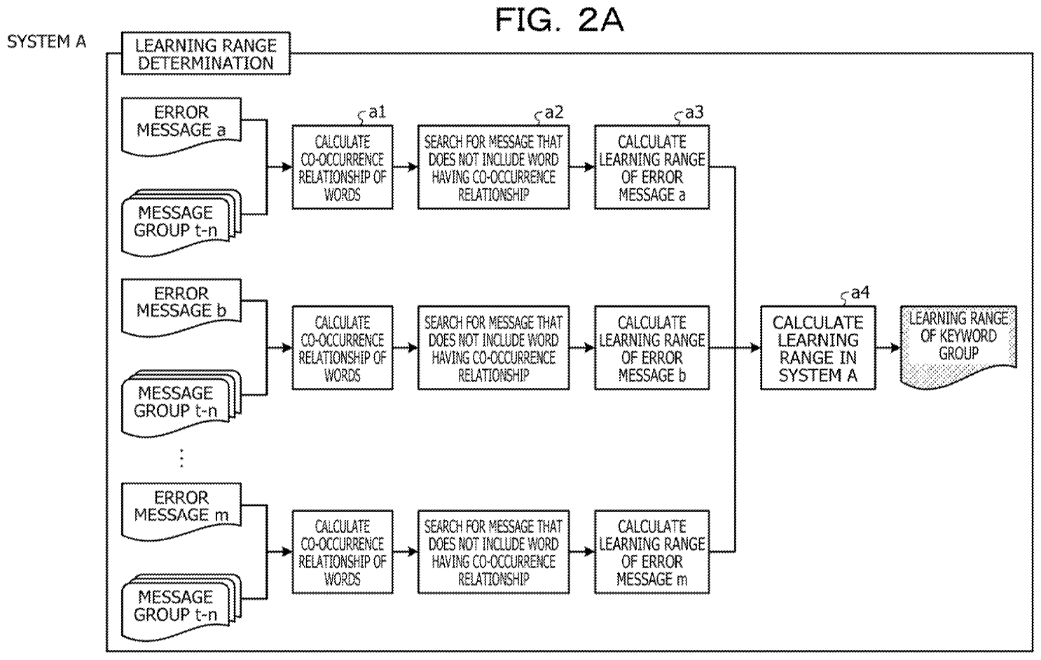

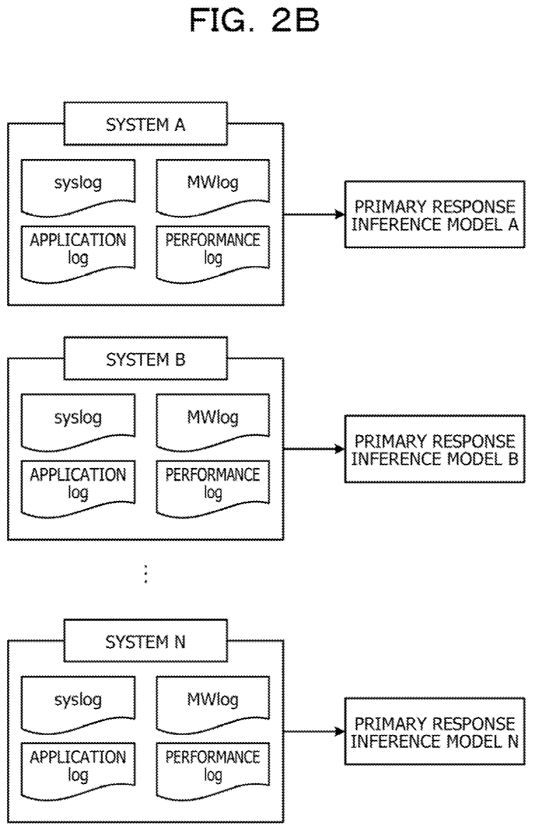

A flow of learning processing for learning the relationships between the past message groups and the primary responses will be described with reference to FIGS. 2A and 2B. FIG. 2A and FIG. 2B are diagrams illustrating an example of the flow of learning processing according to the embodiment.

As illustrated in FIG. 2A, for each monitoring target system 5, the monitoring apparatus 1 determines a learning range in which messages are to be learned, based on information on the dates and times of occurrence of the past message groups and word information included in each message. A flow of learning processing in a system A that is the monitoring target system 5 is described in this example. For example, the monitoring apparatus 1 sets a time point at which a message a occurs in the system A as t, and calculates a co-occurrence relationship of words in a range including the message a and a predetermined number of messages that have occurred before the time point t (a1). The co-occurrence relationship herein means a relationship in which there is a link between the words. The monitoring apparatus 1 further searches the messages in a direction opposite to the chronological order, and searches for a message that does not include the words having the calculated co-occurrence relationship (a2). The monitoring apparatus 1 calculates a learning range of the error message a (a3). For example, the monitoring apparatus 1 calculates, as the learning range of the error message a, the number of messages that are before the time point t and that are messages to a message one before the message searched for in a2. The monitoring apparatus 1 similarly calculates the learning range for each of error messages b, . . . , m.

The monitoring apparatus 1 calculates the learning range in the system A by using the learning ranges for the error messages a, b, . . . , and m (a4).

The monitoring apparatus 1 determines the calculated learning range as the learning range used in generation of the primary response inference model to be described later.

As illustrated in FIG. 2B, the monitoring apparatus 1 generates the primary response inference models for the respective monitoring target systems 5, the primary response inference models each having the determined learning range as a parameter. The primary response inference models are each a learning model that uses keywords obtained from date and time information, primary responses (forwarding destinations), and message contents included in the past messages as training data, and learns a pattern of the primary responses with respect to the keywords. The keywords herein are words that may serve as a basis when the person in charge of operation determines the primary response in the message. For example, the keywords are words that suggest the primary response (forwarding destination) of the message.

The monitoring apparatus 1 generates a primary response inference model A that has the determined learning range as the parameter, for the system A that is the monitoring target system 5. The monitoring apparatus 1 generates a primary response inference model B that has the determined learning range as the parameter, for a system B that is the monitoring target system 5. The monitoring apparatus 1 generates a primary response inference model N that has the determined learning range as the parameter, for a system N that is the monitoring target system 5.

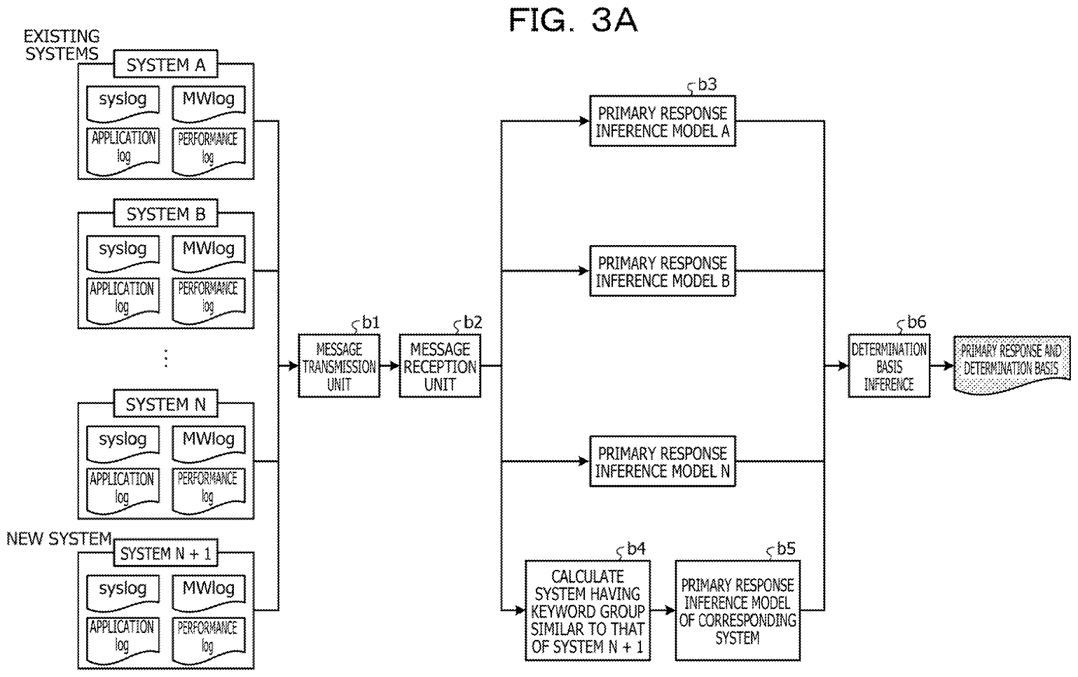

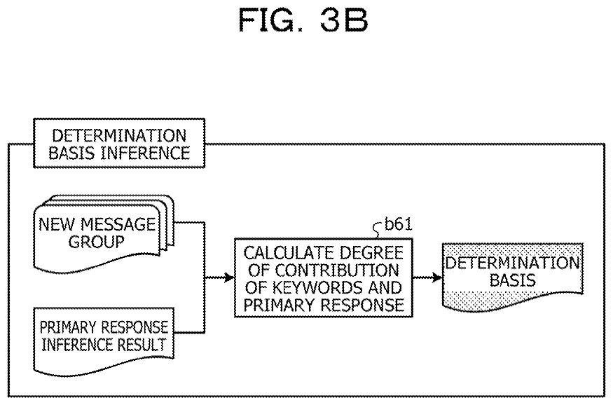

A flow of inference processing for inferring the primary response when a message is received from the monitoring target system 5 is described with reference to FIGS. 3A and 3B. FIGS. 3A and 3B are diagrams illustrating an example of the flow of inference processing according to the embodiment. Systems A to N are assumed to be existing monitoring target systems 5, and a system N+1 is assumed to be a new monitoring target system 5.

As illustrated in FIG. 3A, when the monitoring apparatus 1 receives a message transmitted from any of the monitoring target systems 5 (b1, b2), the monitoring apparatus 1 determines the primary response inference model to be applied. When the monitoring apparatus 1 receives messages transmitted from the systems A to N that are the monitoring target systems 5, the monitoring apparatus 1 determines primary response inference models A to N corresponding to the transmission sources as the primary response inference models to be applied. The monitoring apparatus 1 applies the determined primary response inference models to the new messages to infer the primary responses (b3).

When the monitoring apparatus 1 receives a message transmitted from the system N+1 that is the monitoring target system 5, the monitoring apparatus 1 searches for an existing system having a keyword group similar to that of the received message. For example, the monitoring apparatus 1 calculates a similarity of keywords between a new message group occurring from the system N+1 and a message group used in the learning processing for each existing system, and calculates an existing system with the highest similarity (b4). The monitoring apparatus 1 determines the primary response inference model of the calculated existing system as the primary response inference model to be applied. The monitoring apparatus 1 applies the determined primary response inference model to the new message to infer the primary response (b5).

The monitoring apparatus 1 then infers a determination basis for the inference result of the primary response (b6). An inference processing of the determination basis is illustrated in, for example, FIG. 3B. As illustrated in FIG. 3B, the monitoring apparatus 1 uses the new message group and the inference result of the primary response to calculate a degree of contribution of keywords included in the new messages and the inferred primary response (b61). For example, the monitoring apparatus 1 calculates keywords that have affected the inference result of the primary response as the determination basis. The monitoring apparatus 1 presents the calculated primary response and the determination basis to the person in charge of operation. In the determination basis inference processing, the determination basis may be inferred by using an algorithm such as, for example, Shapley additive explanations (SHAP) used to obtain a contribution of each feature amount to an inference result of a model.

The monitoring apparatus 1 may thus reduce a load of error message response performed by the person in charge of operation.

Returning to FIG. 1, the monitoring apparatus 1 includes a learning unit 10, an inference unit 20, and a storage unit 30. The learning unit 10 includes a past message input unit 11, a past message preprocessing unit 12, a keyword classification unit 13, a learning range determination unit 14, a forwarding destination learning unit 15, and a forwarding destination inference model output unit 16. The inference unit 20 includes a new message reception unit 21, a keyword determination unit 22, a similar word search unit 23, a forwarding destination inference model determination unit 24, a forwarding destination inference unit 25, and a forwarding destination output unit 26. The storage unit 30 includes a past message storage unit 31, a keyword dictionary storage unit 32, a non-keyword dictionary storage unit 33, a learning range storage unit 34, a keyword vector storage unit 35, and a forwarding destination inference model storage unit 36. The learning range determination unit 14 is an example of a determination unit. The forwarding destination learning unit 15 is an example of a generation unit. The forwarding destination inference unit 25 is an example of a selection unit.

The past message storage unit 31 stores past messages transmitted from the monitoring target systems 5. The past message storage unit 31 is generated by the past message input unit 11 to be described later. The keyword dictionary storage unit 32 stores keywords obtained from the past messages. The non-keyword dictionary storage unit 33 stores non-keywords obtained from the past messages. The keyword dictionary storage unit 32 and the non-keyword dictionary storage unit 33 are generated by the keyword classification unit 13 to be described later.

The learning range storage unit 34 stores the learning range for each monitoring target system 5. The learning range storage unit 34 is generated by the learning range determination unit 14 to be described later. The keyword vector storage unit 35 stores keyword vectors obtained by vectorizing the keywords. The keyword vector storage unit 35 is generated by the forwarding destination learning unit 15 to be described later. The forwarding destination inference model storage unit 36 stores a forwarding destination inference model for each monitoring target system 5. The forwarding destination inference model herein corresponds to the primary response inference model illustrated in FIG. 2B. The forwarding destination inference model storage unit 36 is generated by the forwarding destination inference model output unit 16 to be described later.

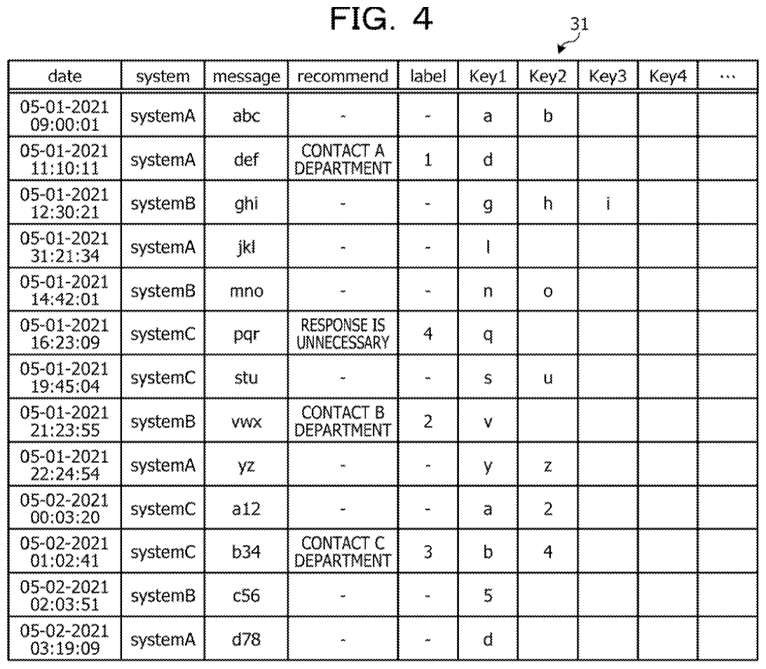

The past message input unit 11 inputs the past messages. For example, the past message input unit 11 inputs the past messages for each monitoring target system 5. The past message input unit 11 stores the inputted past messages in the past message storage unit 31. An example of past message data will be described with reference to FIG. 4.

An example of the past message data stored in the past message storage unit 31 will be described with reference to FIG. 4. FIG. 4 is a diagram illustrating the example of the past message data. As illustrated in FIG. 4, the past message data is data of past messages including regular (normal) and error (abnormal). The past message data is data in which a date, a system, a message, a recommend, a label, a Key1, a Key2, a Key3, a Key4, . . . are associated with one another. The date is a date and time at which the message has occurred. The system indicates an identifier of the monitoring target system 5 in which the message has occurred. The message is the content of the message. The recommend is information recommended to the person in charge of operation for the message. In the recommend, “forwarding destination” is set in the case where a response is desired, and “response is unnecessary” is set in the case where no response is desired. The label is a label that uniquely identifies the content of the recommend. For example, the label may be a label indicating the forwarding destination. The Key1 to Key4 . . . indicate the keywords obtained from the message. For example, the Key1 to Key4 . . . are set by the keyword classification unit 13 to be described later.

As an example, when the date is “2021 May 1 11:10:11”, “system1” is stored as the system, “def” is stored as the message, “contact A department” is stored as the recommend, “1” is stored as the label, and “d” is stored as the Key1.

Returning to FIG. 1, the past message preprocessing unit 12 performs processing of shaping sentence data (message) included in each past message. For example, the past message preprocessing unit 12 deletes characters that are noise in the analysis of the past message, and shapes the past message. The characters that are noise refer to, for example, meaningless symbols, numbers, and the like.

The keyword classification unit 13 classifies words included in the past messages into keywords and non-keywords. For example, the keyword classification unit 13 divides the message of each past message stored in the past message storage unit 31 into words. Processing of dividing the message into words may be performed by using, for example, morphological analysis. The keyword classification unit 13 classifies the divided words into the keywords and the non-keywords. For example, in the case where the keywords are stored in history information in the past forwarding destination determination, the history information may be used for the keyword classification. When there is no history information, the keyword classification may be manually performed. The keyword classification unit 13 sets the keywords in Key items of the past message. The keyword classification unit 13 stores the keywords in the keyword dictionary storage unit 32 and stores the non-keywords in the non-keyword dictionary storage unit 33.

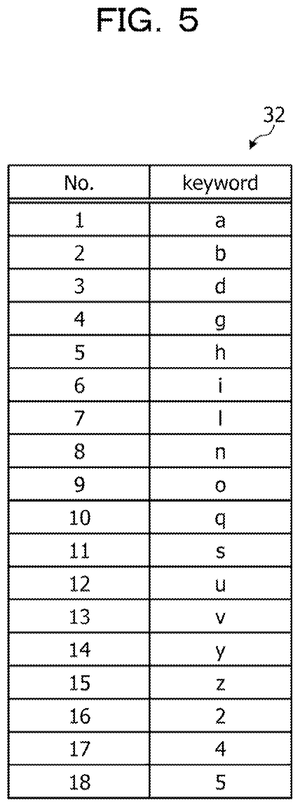

An example of keyword data stored in the keyword dictionary storage unit 32 will be described with reference to FIG. 5. FIG. 5 is a diagram illustrating an example of the keyword data. As illustrated in FIG. 5, in the keyword data, a No. and a keyword are associated with each other. The No. is an identification number uniquely identifying the keyword. The keyword is a word indicating the keyword. As an example, when the No. is “1”, “a” is stored as the keyword.

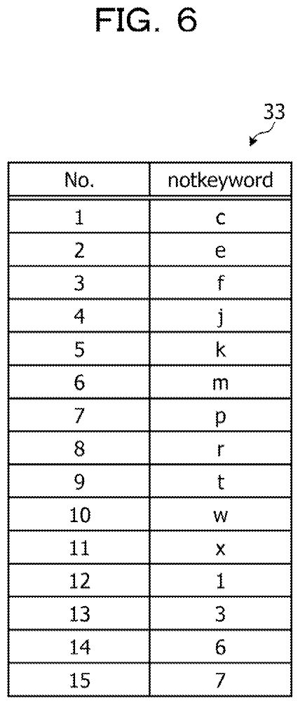

An example of non-keyword data stored in the non-keyword dictionary storage unit 33 will be described with reference to FIG. 6. FIG. 6 is a diagram illustrating an example of the non-keyword data. As illustrated in FIG. 6, in the non-keyword data, a No. and a notkeyword are associated with each other. The No. is an identification number uniquely identifying the notkeyword. The notkeyword is a word indicating the non-keyword. As an example, when the No. is “1”, “c” is stored as the notkeyword.

The learning range determination unit 14 determines the learning 20 range used for the forwarding destination inference model based on the past message group, for each monitoring target system 5. For example, description is given of the case where the learning range determination unit 14 determines a learning range in a certain monitoring target system 5. The learning range determination unit 14 sets a time point at which an error message among multiple past messages has occurred as t, and calculates a co-occurrence relationship between words in a range (here, described as t-n) of n past messages that have occurred before the time point t. Here, n is a threshold value indicating a range of past messages assumed to be related to the error message.

The learning range determination unit 14 further searches each of the past messages in a direction opposite to the chronological order, and determines whether or not the searched past message includes a word having the co-occurrence relationship calculated for the range of t-n. When the searched past message does not include the word having the co-occurrence relationship calculated for the range of t-n, the learning range determination unit 14 calculates the number of past messages from the error message a to a message one before to the searched past message, as the learning range. As an example, the learning range determination unit 14 searches the past messages from t-n−1, to t-n−2, . . . , to t-n-i, and to t-n-(i+1). When the learning range determination unit 14 finds a past message that does not include a word having the co-occurrence relationship calculated for the range of t-n at t-n-(i+1), the learning range determination unit 14 determines that the learning range of the error message a is “n+i” that includes past messages one before the found past message. Here, i corresponds to a time point of the past message immediately before the past message that does not include a word having the co-occurrence relationship calculated for the past message range of t-n. The learning range determination unit 14 determines the learning ranges for the other multiple error messages in the same manner.

The learning range determination unit 14 determines the learning range in a certain monitoring target system 5 based on the learning ranges for multiple error messages issued by the certain monitoring target system 5. As an example, the learning range determination unit 14 determines an average value of the learning ranges for the multiple error messages issued by the certain monitoring target system 5, as the learning range in the certain monitoring target system 5. In the learning range determination unit 14, the learning range is not limited to the average value, and may be a median value or a mode value.

The learning range determination unit 14 stores the determined learning range in the learning range storage unit 34 for each monitoring target system 5.

The learning range determination unit 14 may thus determine the optimal learning range of the messages for each monitoring target system 5. For example, the learning range determination unit 14 may determine the optimal learning range indicating a range of messages to be set as one group, for each monitoring target system 5.

The forwarding destination learning unit 15 generates the forwarding destination inference model for the respective monitoring target systems 5, the forwarding destination inference model each having the determined learning range as a parameter.

For example, description is given of the case where the forwarding destination learning unit 15 generates a forwarding destination inference model in a certain monitoring target system 5. The forwarding destination learning unit 15 reads out the past message group associated with the certain monitoring target system 5 from the past message storage unit 31. The forwarding destination learning unit 15 sorts the read-out past message group by date and time. The forwarding destination learning unit 15 generates keyword vectors obtained by vectorizing keywords in the past messages. For example, a method 15 such as term frequency-inverse document frequency (Tf-idf) may be used as a vectorization method. Tf-idf is an algorithm for vectorizing words in a sentence and extracting a feature word of the sentence by using an index called a term frequency (TF) and an index called an inverse document frequency (IDF). The forwarding destination learning unit 15 reduces the number of dimensions of each of the vectorized keywords. For example, the forwarding destination learning unit 15 reduces the vector into information of a lower dimension while maintaining meaning of information of multiple dimensions. This is performed to reduce the amount of data or to create a feature amount and resultantly improve the accuracy of the learning model. The forwarding destination learning unit 15 stores the keyword vectors in the keyword vector storage unit 35 for each past message.

The forwarding destination learning unit 15 generates the forwarding destination inference model that outputs the forwarding destination by using the keywords as an input. For example, the forwarding destination learning unit 15 generates a forwarding destination inference model that learns a pattern of the forwarding destinations with respect to the keywords in the past messages. The forwarding destination inference model is generated by using a long short-term memory (LSTM) method. LSTM is one of deep learning algorithms suitable for analysis of time-series data. Training data to be inputted into LSTM is, for example, data in which the date and time in the past message, the label indicating the forwarding destination, and the keyword vectors are associated with one another. The learning range determined by the learning range determination unit 14 is set in LSTM as a parameter. Although the forwarding destination inference model is described to be generated by using the LSTM method, the method of generation is not limited to this. The forwarding destination inference model may be generated by using a known machine learning algorithm such as a neural network.

The forwarding destination learning unit 15 uses the learning range of each monitoring target system 5 for the learning of forwarding destinations. This allows the forwarding destination learning unit 15 to perform the learning of forwarding destinations within the learning range of the time-series messages related to one another and improve the accuracy of the forwarding destination inference model.

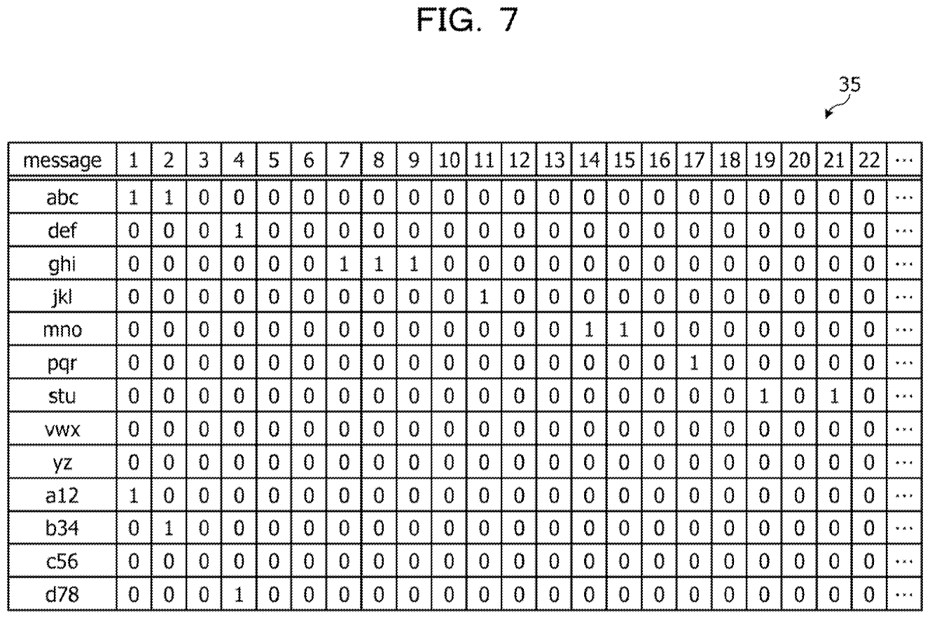

An example of keyword vector data stored in the keyword vector storage unit 35 will be described with reference to FIG. 7. FIG. 7 is a diagram illustrating an example of the keyword vector data. As illustrated in FIG. 7, the keyword vector data is information in which the messages of the past messages and the keyword vectors are associated with one another. As an example, keyword vectors in the case where the message of the past message is “abc” are associated with each other.

Returning to FIG. 1, the forwarding destination inference model output unit 16 outputs the forwarding destination inference model generated for each monitoring target system 5. For example, the forwarding destination inference model output unit 16 stores the forwarding destination inference model generated for each monitoring target system 5 in the forwarding destination inference model storage unit 36.

The new message reception unit 21 receives the new message group from the monitoring target system 5. The received new message group may be multiple messages or one message.

When the new message group is messages received from a new monitoring target system 5, the keyword determination unit 22 determines keywords for the new message group. For example, the keyword determination unit 22 divides each new message in the new message group into words. The keyword determination unit 22 determines whether each divided word is the keyword or the non-keyword by using the keyword dictionary storage unit 32 and the non-keyword dictionary storage unit 33. When the keyword determination unit 22 is unable to determine whether the divided word is the keyword or the non-keyword, the keyword determination unit 22 determines that the word is a new word, and causes the similar word search unit 23 to search for a word similar to the new word. The keyword determination unit 22 outputs the keywords in the new messages to the forwarding destination inference model determination unit 24.

The similar word search unit 23 searches for a word (similar word) similar to a word. For example, when the similar word search unit 23 receives a search target word from the keyword determination unit 22, the similar word search unit 23 calculates a similar word of the search target word. The similar word of the search target word may be calculated by using a method such as, for example, Word2vec.

When the new message group is messages received from the new monitoring target system 5, the forwarding destination inference model determination unit 24 determines the forwarding destination inference model to be applied to the new message group. For example, the forwarding destination inference model determination unit 24 sorts the new message group by the dates and times at which the messages have occurred. The forwarding destination inference model determination unit 24 vectorizes the keywords in the new messages by the same method as the method of vectorizing the keywords in the past messages. The forwarding destination inference model determination unit 24 calculates a degree of similarity between time-series data of the new message group and time-series data of the past message group of each monitoring target system 5 by using the keyword vectors of the new message group and the keyword vectors of the past message group. The degree of similarity may be calculated by using a method such as, for example, dynamic time warping (DTW). DTW is a method for measuring a distance and a degree of similarity between pieces of time-series data, and enables measurement of a degree of similarity between two pieces of time-series data by obtaining distances between items in one of the two pieces of data and items in the other piece of data for all combinations of the items and obtaining all distances. The forwarding destination inference model determination unit 24 selects the monitoring target system 5 having the highest similarity, and determines the forwarding destination inference model of the selected monitoring target system 5 as the inference model to be applied to the new message group. Accordingly, even when a new monitoring target system 5 is added, the forwarding destination inference model determination unit 24 may apply, to the new message group, the forwarding destination inference model of the existing monitoring target system 5 that has transmitted time-series messages similar to the new message group.

When the new message group is messages received from the existing monitoring target system 5, the forwarding destination inference model determination unit 24 may determine the forwarding destination inference model corresponding to the existing monitoring target system 5 as the forwarding destination inference model to be applied.

The forwarding destination inference unit 25 infers the forwarding destination of the new message group by using the determined forwarding destination inference model. For example, the forwarding destination inference unit 25 inputs the keywords of the new message group into the forwarding destination inference model, and infers the forwarding destination and the degree of contribution (reliability) of the forwarding destination by using the forwarding destination inference model. The forwarding destination inference unit 25 also calculates the keywords (determination basis) that have affected the inferred forwarding destination by using an algorithm such as, for example, SHAP. As an example, the forwarding destination inference unit 25 inputs the learned forwarding destination inference model and the keywords of the new message group used for the inference of the forwarding destination into SHAP, and outputs the keywords that have affected the inferred forwarding destination and the degree of effect of the keywords. SHAP is a method of obtaining contribution of each feature amount to an inference result of a model, and is an algorithm for calculating what kind of effect each feature amount (keyword) has on a prediction value (forwarding destination) of a learned model (forwarding destination inference model). The forwarding destination inference unit 25 may thus visualize the keywords that have affected the forwarding destination and the degree of effect of the keywords. The inferred forwarding destination, the degree of contribution, the keywords that have affected the forwarding destination, and the degree of effect herein are referred to as “forwarding destination inference result”.

The forwarding destination output unit 26 outputs the forwarding destination inference result for the new message group to the display apparatus 2. For example, the forwarding destination output unit 26 causes the display apparatus 2 to display the forwarding destination inferred by the forwarding destination inference unit 25 for the new message group and the degree of contribution of the forwarding destination. The forwarding destination output unit 26 also causes the display apparatus 2 to display the keywords that have affected the forwarding destination inferred by the forwarding destination inference unit 25 and the degree of effect of the keywords.

The forwarding destination output unit 26 thus allows any person in charge of operation to determine the forwarding destination that is the primary response for the new message group.

### Example of Determination of Learning Range

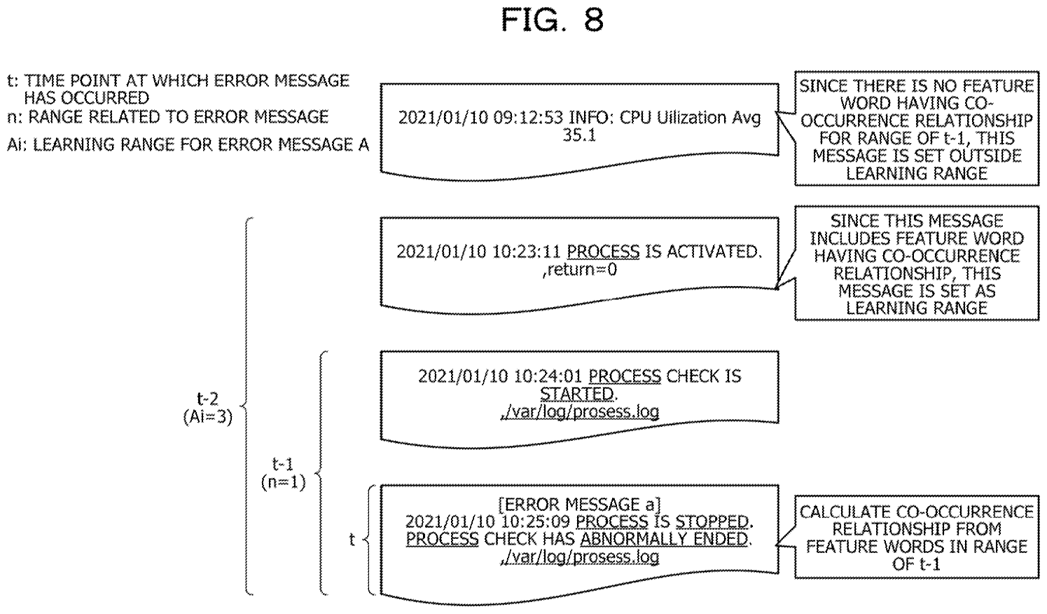

An example of determination of the learning range according to the embodiment will be described with reference to FIG. 8. FIG. 8 is a diagram illustrating an example of the determination of the learning range according to the embodiment. In FIG. 8, description will be given assuming that the threshold n indicating the range of messages related to the error message is “1”.

As illustrated in FIG. 8, the learning range determination unit 14 sets a time point at which an error message a has occurred in a certain monitoring target system 5 as t. The learning range determination unit 14 calculates the co-occurrence relationship between words in a range including an error message a and n (=1) messages before the time point t. The learning range determination unit 14 calculates the co-occurrence relationship between words from feature words such as “process”, “start”, “abnormal end”, and “var/log/process.log” in the range of t-1. Words calculated as feature words having the co-occurrence relationship are “process”, “start”, and “var/log/process.log”.

The learning range determination unit 14 further searches a message of t-2, and determines whether or not the message of t-2 includes any of the words having the co-occurrence relationship calculated for the range of t-1. In this case, the message of t-2 includes the word “process” having the co-occurrence relationship calculated for the range of t-1. The learning range determination unit 14 thus sets t-2 as the learning range.

The learning range determination unit 14 further searches a message of t-3, and determines whether or not the message of t-3 includes any of the words having the co-occurrence relationship calculated for the range of t-1. In this case, the message of t-3 includes no word having the co-occurrence 30 relationship calculated for the range of t-1. The learning range determination unit 14 thus does not set t-3 as the learning range. The learning range determination unit 14 determines that the learning range of the error message a is “3” that is the number of messages to a message one before the message of t-3. For example, the learning range determination unit 14 determines that the learning range of the error message a is “3”.

The learning range determination unit 14 determines the learning ranges for the other multiple error messages in the same manner. The learning range determination unit 14 determines an average value of the learning ranges for the multiple error messages, as the learning range in the certain monitoring 10 target system 5.

### Example of Past Message in which Keywords Are Vectorized

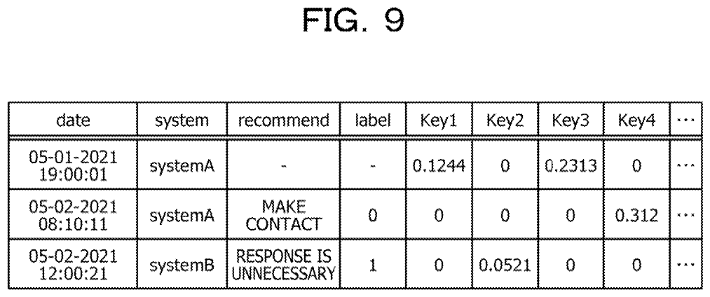

An example of keyword vectorization performed by the forwarding destination learning unit 15 will be described with reference to FIG. 9. FIG. 9 is an example of the past message data in which the keywords are vectorized. As illustrated in FIG. 9, the forwarding destination learning unit 15 uses a method such as Tf-idf to generate the keyword vectors obtained by vectorizing the keywords in the past messages. In each past message, the keyword vectors of the respective keywords are set in the items of Key1, Key2, Key3, and Key4.

### Example of Forwarding Destination Inference Model Determination Result

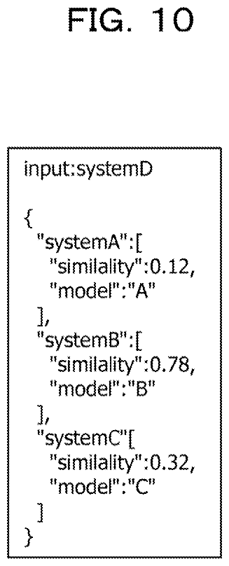

An example of a result of the forwarding destination inference model determination processing performed by the forwarding destination inference model determination unit 24 will be described with reference to FIG. 10. FIG. 10 is a diagram illustrating one example of the forwarding destination inference model determination result according to the embodiment. FIG. 10 describes determination of the forwarding destination inference model to be applied to a new message group in the case where the new monitoring target system 5 is “system D”. Note that “system A”, “system B”, and “system C” are present as the existing monitoring target systems 5, and forwarding destination inference models “A”, “B”, and “C” are generated for the respective systems.

As illustrated in FIG. 10, the forwarding destination inference model determination unit 24 sorts the new message group from “system D” by dates and times at which messages have occurred. The forwarding destination inference model determination unit 24 vectorizes the keywords in the new messages by the same method as the method of vectorizing the keywords in the past messages. The forwarding destination inference model determination unit 24 calculates a degree of similarity between the time-series data of the past message group of “system A” and the time-series data of the new messages by using the keyword vectors of the past message group and the keyword vectors of the new messages. The forwarding destination inference model determination unit 24 calculates a degree of similarity between the time-series data of the past message group of “system B” and the time-series data of the new messages by using the keyword vectors of the past message group and the keyword vectors of the new messages. The forwarding destination inference model determination unit 24 calculates a degree of similarity between the time-series data of the past message group of “system C” and the time-series data of the new messages by using the keyword vectors of the past message group and the keyword vectors of the new messages. In this example, a degree of similarity to “system A” is calculated as “0.12”, a degree of similarity to “system B” is calculated as “0.78”, and a degree of similarity to “system C” is calculated as “0.32”.

The forwarding destination inference model determination unit 24 selects “system B” as the monitoring target system 5 having the highest similarity, and determines the forwarding destination inference model “B” of the selected “system B” as the forwarding destination inference model to be applied to the new messages.

### Example of Forwarding Destination Inference Result

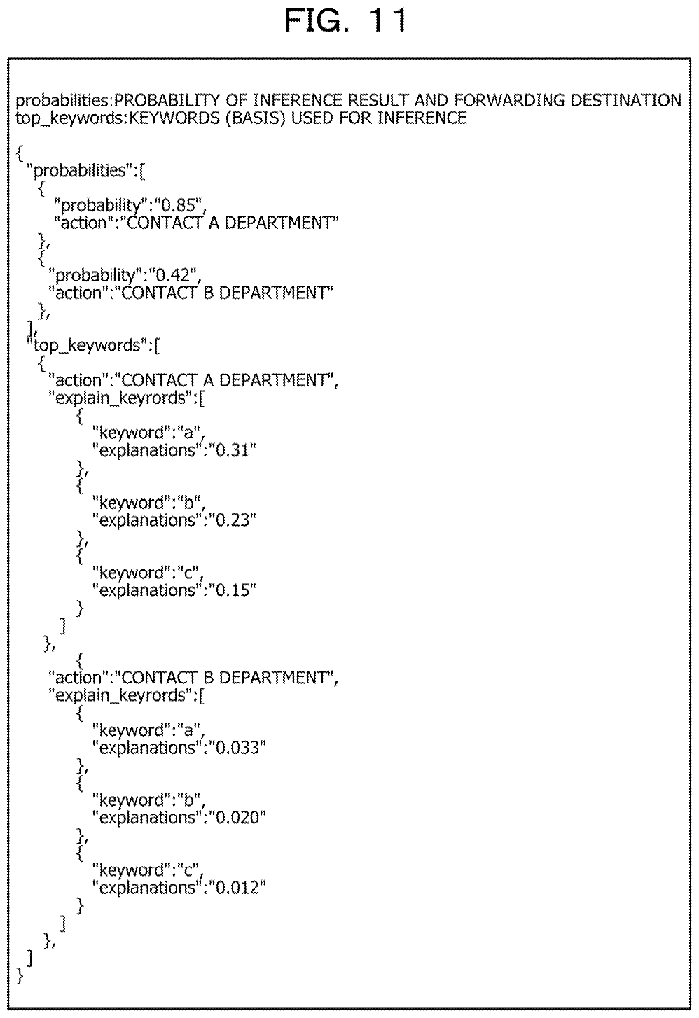

An example of the forwarding destination inference result inferred by the forwarding destination inference unit 25 will be described with reference to FIG. 11. FIG. 11 is a diagram illustrating an example of the forwarding destination inference result according to the embodiment. FIG. 11 illustrates a forwarding destination inference result in which a forwarding destination for a message group occurring from a certain monitoring target system 5 is inferred. Forwarding destinations and probabilities (degree of contribution) are described as the inference result under the “probabilities” of the forwarding destination inference result. For example, such information is a result of an operation in which the forwarding destination inference unit 25 inputs the keywords of the new message group into the forwarding destination inference model and infers the forwarding destination and the degree of contribution by using the forwarding destination inference model. Keywords (basis) and probabilities (degrees of effect) used for the inference are also described for each inferred forwarding destination under “top_keywords” of the forwarding destination inference result. For example, such information is a result of an operation in which the forwarding destination inference unit 25 inputs the learned forwarding destination inference model and the keywords of the new message group used in the inference of the forwarding destination into SHAP and outputting the keywords that have affected the inference result and the degrees of effect of the keywords.

As an example, a probability (degree of contribution) in the case where the inferred forwarding destination is “contact A department” is described as “0.85”. A probability (degree of contribution) in the case where the inferred forwarding destination is “contact B department” is described as “0.42”. When the forwarding destination is “contact A department”, a keyword “a” having affected the inference result is described to have a degree of effect of “0.31”. A keyword “b” having affected the inference result is described to have a degree of effect of “0.23”. A keyword “c” having affected the inference result is described to have a degree of effect of “0.15”. When the forwarding destination is “contact B department”, a keyword “a” having affected the inference result is described to have a degree of effect of “0.033”. A keyword “b” having affected the inference result is described to have a degree of effect of “0.020”. A keyword “c” having affected the inference result is described to have a degree of effect of “0.012”.

The forwarding destination output unit 26 causes the display apparatus 2 to display such a forwarding destination inference result, and this allows any person in charge of operation to determine the forwarding destination that is the primary response for the error message. For example, the monitoring apparatus 1 may reduce the load of error message response performed by the person in charge of operation.

### Flowchart of Entire Monitoring System

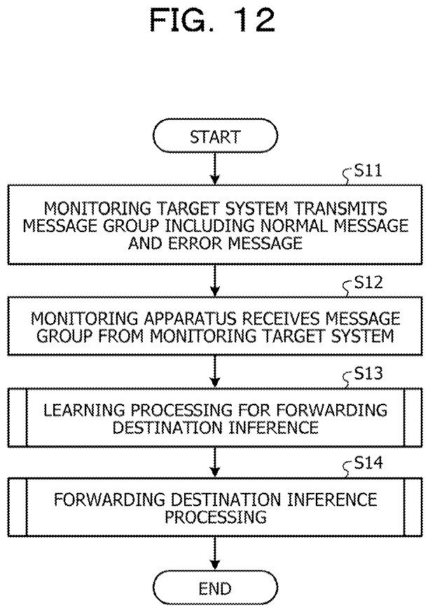

FIG. 12 is a diagram illustrating an example of a flowchart of the entire monitoring system according to the embodiment.

As illustrated in FIG. 12, the monitoring target system 5 sends a message group including the normal message and the error message (step S11). The monitoring apparatus 1 receives the message group from the monitoring target system 5 (step S12).

The monitoring apparatus 1 performs the learning processing for the inference of the forwarding destination (step S13). A flowchart of the learning processing will be described later. The monitoring apparatus 1 performs the forwarding destination inference processing (step S14). A flowchart of the inference processing will be described later. The monitoring apparatus 1 then terminates the entire processing.

### Flowchart of Learning Processing

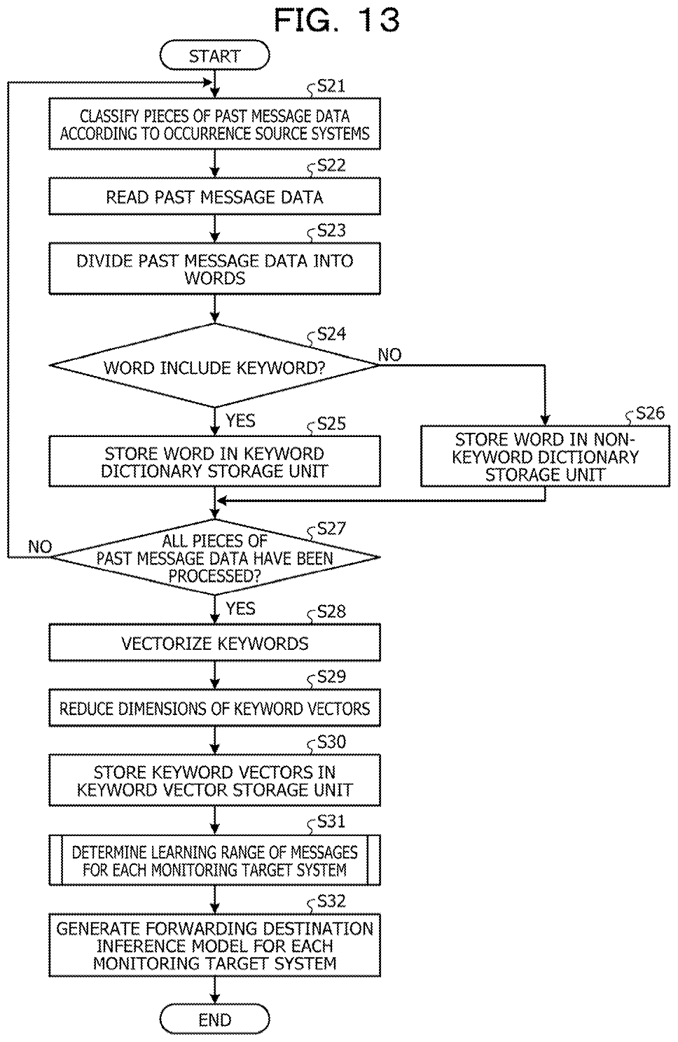

FIG. 13 is a view illustrating an example of the flowchart of the learning processing according to the embodiment. As illustrated in FIG. 13, the monitoring apparatus 1 classifies pieces of past message data according to the occurrence source monitoring target systems 5 (step S21). The monitoring apparatus 1 reads a piece of past message data (step S22). The monitoring apparatus 1 divides the past message data into words (step S23).

The monitoring apparatus 1 determines whether or not each of the words include the keyword (step S24). When the monitoring apparatus 1 determines that the word includes the keyword (step S24; Yes), the monitoring apparatus 1 stores the word as the keyword in the keyword dictionary storage unit 32 (step S25). The monitoring apparatus 1 proceeds to step S27.

Meanwhile, when the monitoring apparatus 1 determines that the word does not include the keyword (step S24; No), the monitoring apparatus 1 stores the word as the non-keyword in the non-keyword dictionary storage unit 33 (step S26). The monitoring apparatus 1 proceeds to step S27.

In step S27, the monitoring apparatus 1 determines whether or not all pieces of past message data have been processed (step S27). When the monitoring apparatus 1 determines that not all of the pieces of past message data have been processed (step S27; No), the monitoring apparatus 1 proceeds to step S21.

Meanwhile, when the monitoring apparatus 1 determines that all pieces of past message data have been processed (step S27; Yes), the monitoring apparatus 1 vectorizes the keywords in each piece of past message data (step S28). The monitoring apparatus 1 reduces the dimensions of the keyword vectors (step S29). The monitoring apparatus 1 stores the keyword vectors in the keyword vector storage unit 35 (step S30).

The monitoring apparatus 1 determines the learning range of messages for each monitoring target system 5 (step S31). A flowchart of the learning range determination processing will be described later.

The monitoring apparatus 1 generates the forwarding destination inference model for each monitoring target system 5 (step S32). The monitoring apparatus 1 terminates the learning processing.

### Flowchart of Learning Range Determination Processing

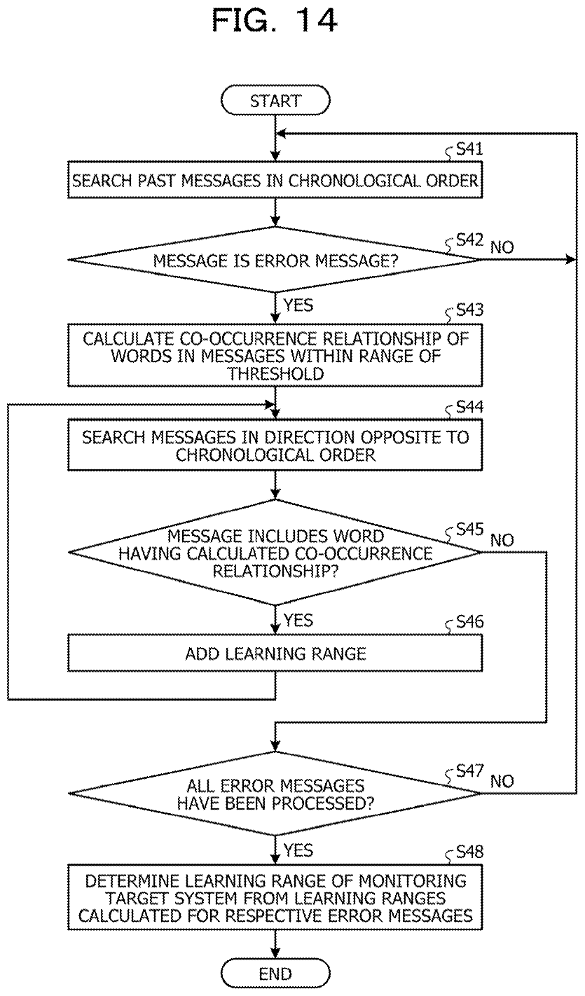

FIG. 14 is a diagram illustrating an example of a flowchart of the learning range determination processing according to the embodiment. The following flowchart is executed for each monitoring target system 5.

As illustrated in FIG. 14, the monitoring apparatus 1 searches each of the past messages in chronological order (step S41). The monitoring apparatus 1 determines whether or not a past message to be processed is the error message (step S42). When the monitoring apparatus 1 determines that the past message to be processed is not the error message (step S42; No), the monitoring apparatus 1 proceeds to step S41 and searches the next past message.

Meanwhile, when the monitoring apparatus 1 determines that the past message to be processed is the error message (step S42; Yes), the monitoring apparatus 1 calculates the co-occurrence relationship of the words in the past messages within the range of the threshold n before the time point at which the error message has occurred (step S43). The threshold n is the learning range of messages assumed to be related to the error message. The monitoring apparatus 1 sets the learning range to the threshold value n.

The monitoring apparatus 1 searches each of the past messages in the direction opposite to the chronological order (step S44). The monitoring apparatus 1 determines whether or not the searched past message includes the word having the co-occurrence relationship calculated for the range of the threshold n (step S45). When the monitoring apparatus 1 determines that the searched past message includes the word having the co-occurrence relationship calculated for the range of the threshold value n (step S45; Yes), the monitoring apparatus 1 adds a learning range (step S46). The monitoring apparatus 1 proceeds to step S44 to search the next past message.

Meanwhile, when the monitoring apparatus 1 determines that the searched past message does not include the word having the calculated co-occurrence relationship (step S45; No), the monitoring apparatus 1 determines whether or not all error messages have been processed (step S47). When the monitoring apparatus 1 determines that not all of the error messages have been processed (step S47; No), the monitoring apparatus 1 proceeds to step S41 to search the error message.

Meanwhile, when the monitoring apparatus 1 determines that all error messages have been processed (step S47; Yes), the monitoring apparatus 1 determines the learning range of the monitoring target system 5 from the learning ranges calculated for the respective error messages (step S48). For example, the monitoring apparatus 1 determines an average value of the learning ranges calculated for the respective error messages as the learning range in the monitoring target system 5. The monitoring apparatus 1 terminates the learning range determination processing.

### Flowchart of Inference Processing

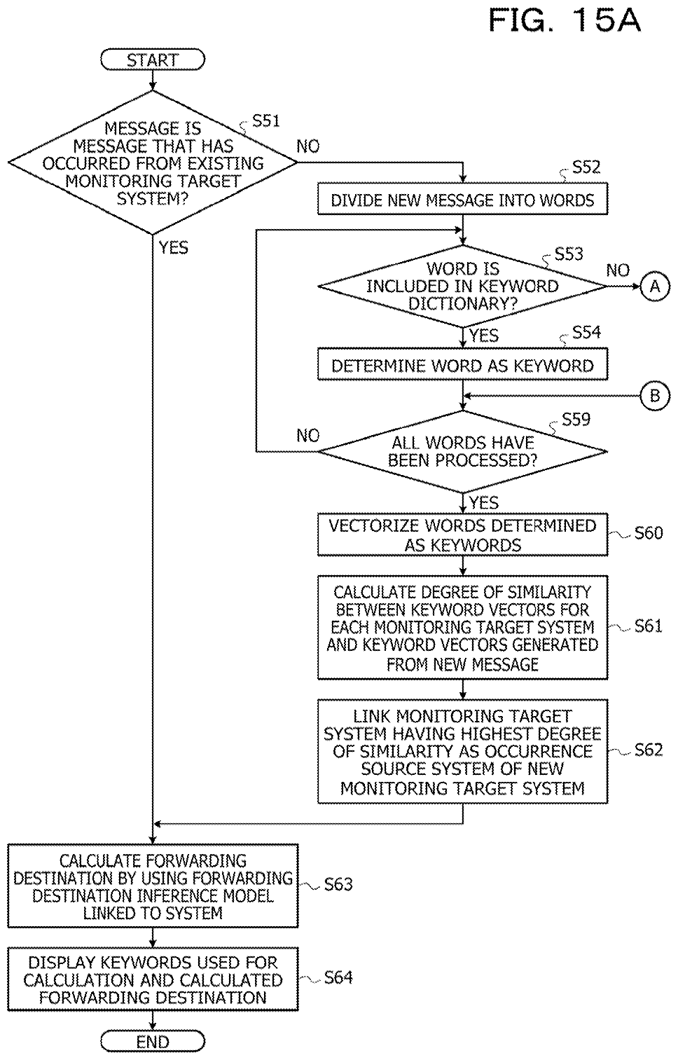

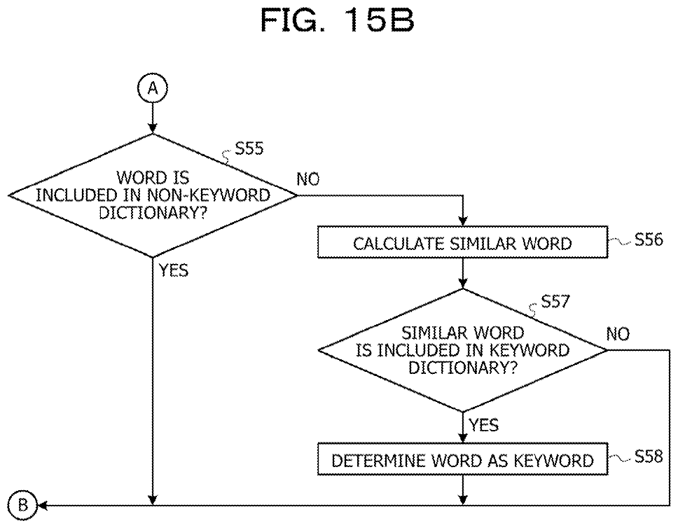

FIGS. 15A and 15B are a diagram illustrating an example of a flowchart of the inference processing according to the embodiment. As illustrated in FIGS. 15A and 15B, the monitoring apparatus 1 determines whether or not a message is a message that has occurred from the existing monitoring target system 5 (step S51). When the monitoring apparatus 1 determines that the message is a message that has occurred from the existing monitoring target system 5 (step S51; Yes), the monitoring apparatus 1 proceeds to step S63.

Meanwhile, when the monitoring apparatus 1 determines that the message is not a message that has occurred from the existing monitoring target system 5 (step S51; No), the monitoring apparatus 1 divides the new message into words (step S52). The monitoring apparatus 1 determines whether or not each of the divided words is included in the keyword dictionary storage unit 32 (step S53). When the monitoring apparatus 1 determines that the divided word is included in the keyword dictionary storage unit 32 (step S53; Yes), the monitoring apparatus 1 determines the divided word as the keyword (step S54). The monitoring apparatus 1 proceeds to step S59 to process the next word.

Meanwhile, when the monitoring apparatus 1 determines that the divided word is not included in the keyword dictionary storage unit 32 (step S53; No), the monitoring apparatus 1 determines whether or not the divided word is included in the non-keyword dictionary storage unit 33 (step S55). When the monitoring apparatus 1 determines that the divided word is included in the non-keyword dictionary storage unit 33 (step S55; Yes), the monitoring apparatus 1 proceeds to step S59 to process the next word.

Meanwhile, when the monitoring apparatus 1 determines that the divided word is not included in the non-keyword dictionary storage unit 33 (step S55; No), the monitoring apparatus 1 calculates a similar word that is similar to the divided word (step S56). The monitoring apparatus 1 determines whether or not the similar word is included in the keyword dictionary storage unit 32 (step S57). When the monitoring apparatus 1 determines that the similar word is not included in the keyword dictionary storage unit 32 (step S57; No), the monitoring apparatus 1 proceeds to step S59 to process the next word.

Meanwhile, when the monitoring apparatus 1 determines that the similar word is included in the keyword dictionary storage unit 32 (step S57; Yes), the monitoring apparatus 1 determines the divided word as the keyword (step S58). The monitoring apparatus 1 proceeds to step S59 to process the next word.

In step S59, the monitoring apparatus 1 determines whether or not all divided words have been processed (step S59). When the monitoring apparatus 1 determines that not all of the divided words have been processed (step S59; No), the monitoring apparatus 1 proceeds to step S53 to process a word that has not been processed yet.

Meanwhile, when the monitoring apparatus 1 determines that all divided words have been processed (step S59; Yes), the monitoring apparatus 1 vectorizes each of the words determined as the keywords (step S60). The monitoring apparatus 1 calculates the degree of similarity by using the keyword vectors of each existing monitoring target system 5 and the keyword vectors generated from the new message (step S61). For example, the monitoring apparatus 1 calculates, for each existing monitoring target system 5, the degree of similarity between the time-series data of the past message group and the time-series data of the new message by using the keyword vectors of the past message group used in the learning processing and the keyword vectors generated from the new message.

The monitoring apparatus 1 links the existing monitoring target system 5 having the highest degree of similarity, as an occurrence source system of the new monitoring target system 5 (step S62). The monitoring apparatus 1 proceeds to step S63.

In step S63, the monitoring apparatus 1 calculates the forwarding destination by using the forwarding destination inference model linked to the monitoring target system 5 to be processed (step S63). For example, the monitoring apparatus 1 inputs the keywords of the new message into the forwarding destination inference model, and infers the forwarding destination and the degree of contribution (reliability) of the forwarding destination by using the forwarding destination inference model. The monitoring apparatus 1 also calculates the keywords (determination basis) that have affected the inferred forwarding destination by using an algorithm such as, for example, SHAP.

The monitoring apparatus 1 displays the keywords used for the calculation and the calculated forwarding destination on the display apparatus 2 (step S64). For example, the monitoring apparatus 1 displays the inferred forwarding destination for the new message and the degree of contribution on the display apparatus 2. The monitoring apparatus 1 also displays the keywords that have affected the inferred forwarding destination and the degree of effect on the display apparatus 2. The monitoring apparatus 1 terminates the inference processing.

### Effects of Embodiment

As described above, in the aforementioned embodiment, the monitoring apparatus 1 determines the learning range, used in the learning of messages, for each monitoring target system 5 based on the time-series information of each of the past message groups and on the keyword information that is obtained from the contents of the messages and that suggests the forwarding destinations of the messages. The monitoring apparatus 1 generates the learning model, used to infer the information on the forwarding destination from the keyword information of the error message, for each monitoring target system 5 by using the determined learning range as the parameter and using the time-series information, the information on the forwarding destination, and the keyword information included in each message in the case where a message is the error message, as the training data. When the monitoring apparatus 1 obtains the error message of the new system, the monitoring apparatus 1 selects the learning model to be applied to the new system from the learning models of the monitoring target systems 5, based on the degree of similarity between the keyword information used in the learning of each monitoring target system 5 and the keyword information of the obtained error message of the new system. According to such a configuration, even when the monitoring apparatus 1 receives the error message from the new system, the monitoring apparatus 1 may reduce the load of error message response performed by the person in charge of operation by using the learning model applied to the new system.

For each of the error messages included in the past message group of each of the monitoring target systems 5, the monitoring apparatus 1 searches the predetermined number of messages that have occurred before the time point at which the error message has occurred, and calculates the co-occurrence relationship between the words in the range including the error message and the searched error messages. The monitoring apparatus 1 further searches the messages in the past direction to a message that does not include the word having the calculated co-occurrence relationship, and calculates the number of messages from the error message to the message one before the message that does not include the word having the calculated co-occurrence relationship, as the learning range. The monitoring apparatus 1 determines the learning range of the monitoring target system 5 by using the learning ranges calculated for the respective error messages. According to such a configuration, the monitoring apparatus 1 may optimally determine to which message the learning range is to be set for each monitoring target system 5.

The monitoring apparatus 1 determines the learning range of the monitoring target system 5 by using any one of the average value, the median value, and the mode value of the learning ranges calculated for the respective error messages. According to such a configuration, the monitoring apparatus 1 may determine an optimal learning range for each monitoring target system 5.

The monitoring apparatus 1 vectorizes the keyword information of each monitoring target system 5 by the predetermined vectorization method, and vectorizes the keyword information of the error message of the new system by the vectorization method. The monitoring apparatus 1 calculates the degree of similarity between the keyword vectors of each monitoring target system 5 and the keyword vectors of the error message of the new system, and selects the learning model of the monitoring target system 5 having the highest degree of similarity, as the learning model to be applied to the new system. According to such a configuration, the monitoring apparatus 1 may reduce the load of response to the error message from the new system by using the learning model of the monitoring target system 5 most similar to the new system.

In the above-described embodiment, the monitoring apparatus 1 inputs the keyword information of the error message of the new system into the selected learning model, and infers the information on the forwarding destination of the error message. The monitoring apparatus 1 also infers the keyword information that has affected the inferred information on the forwarding destination together with the degree of effect of the keyword information by using the predetermined algorithm for obtaining the effect of each piece of keyword information on the inference result of the learning model. According to such a configuration, the monitoring apparatus 1 may present the keyword information that is the determination basis of the forwarding destination being the inference result. As a result, the monitoring apparatus 1 may reduce the load of error message response performed by the person in charge of operation.

In the above-described embodiment, the monitoring apparatus 1 displays the information on the forwarding destination of the error message, the degree of contribution of the information on the forwarding destination, the keyword information that has affected the information on the forwarding destination, and the degree of effect of the keyword information, on the display unit. According to such a configuration, the monitoring apparatus 1 may reduce the load of error message response performed by the person in charge of operation by presenting the forwarding destination that is the primary response for the error message.

### Others

Each of the elements of the monitoring apparatus 1 illustrated in the drawings may not be physically configured as illustrated in the drawings. For example, a specific form of separation or integration of each apparatus is not limited to that illustrated in the drawings, and all or some of the apparatuses may be configured to be functionally or physically separated or integrated in arbitrary units depending on various loads, usage states, and the like. For example, the forwarding destination learning unit 15 may be divided into a first generation unit that generates the keyword vectors and a second generation unit that generates the forwarding destination inference model by using the keyword vectors. The learning range determination unit 14 and the forwarding destination learning unit 15 may be integrated as one unit. The storage unit 30 may be coupled via a network as an external device of the monitoring apparatus 1.

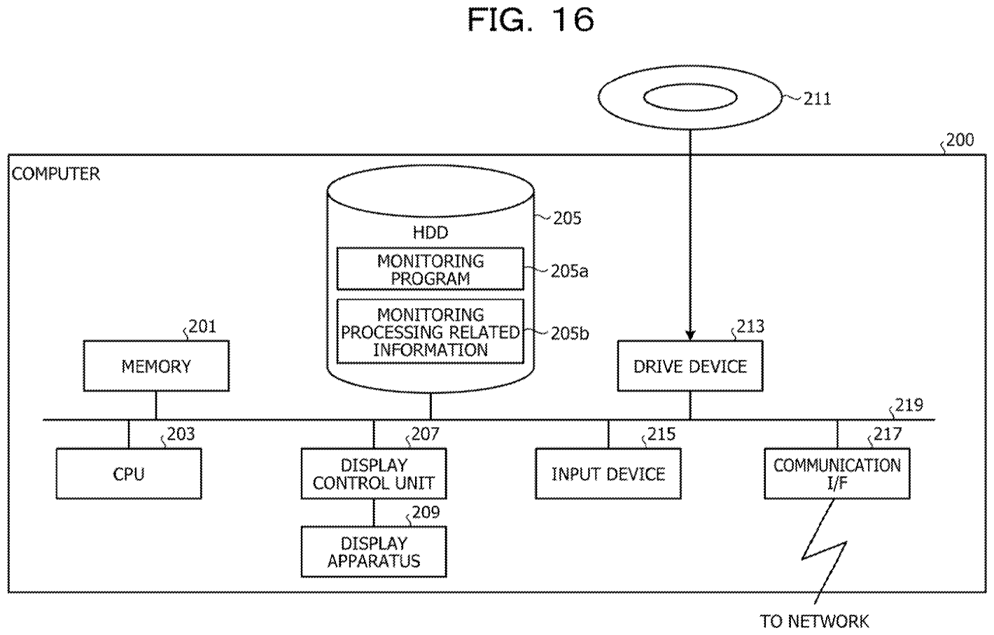

The various kinds of processing described in the above embodiment may be implemented by executing a program prepared in advance with a computer such as a personal computer or a workstation. Description is given below of an example of a computer that executes a monitoring program configured to implement functions similar to those of the monitoring apparatus 1 illustrated in FIG. 1. FIG. 16 illustrates an example of the computer that executes the monitoring program.

As illustrated in FIG. 16, the computer 200 includes a central processing unit (CPU) 203 that executes various types of arithmetic processing, an input device 215 that receives an input of data from a user, and a display apparatus 209. The computer 200 also includes a drive device 213 that reads a program or the like from a storage medium, and a communication interface (I/F) 217 that exchanges data with another computer via a network. The computer 200 also includes a memory 201 that temporarily stores various kinds of information and a hard disk drive (HDD) 205. A bus 219 couples the memory 201, the CPU 203, the HDD 205, the display apparatus 209, the drive device 213, the input device 215, and the communication I/F 217 to one another.

The drive device 213 is, for example, a device for a removable disc 211. A monitoring program 205a and monitoring processing related information 205b are stored in the HDD 205. The communication I/F 217 serves as an interface between the network and the inside of the apparatus, and controls input and output of data from and to another computer. For example, a modem, a LAN adapter, or the like may be employed as the communication I/F 217.

The display apparatus 209 is a display apparatus that displays a cursor, an icon, a tool box, and data such as a document, an image, and function information. For example, a liquid crystal display, an organic electroluminescence (EL) display, or the like may be employed as the display apparatus 209.

The CPU 203 reads the monitoring program 205a, loads the monitoring program 205a to the memory 201, and executes the monitoring program 205a as processes. Such processes correspond to the respective functional units of the monitoring apparatus 1. The monitoring processing related information 205b corresponds to the past message storage unit 31, the keyword dictionary storage unit 32, the non-keyword dictionary storage unit 33, the learning range storage unit 34, the keyword vector storage unit 35, the forwarding destination inference model storage unit 36, and the like. For example, various kinds of information such as the monitoring program 205a are stored in the removable disc 211.

The monitoring program 205a does not have to be stored in the HDD 205 from the beginning. For example, the program may be stored in a “portable physical media” such as a flexible disk (FD), a compact disk read-only memory (CD-ROM), a Digital Versatile Disc (DVD), a magneto-optical disk, or an IC card to be inserted into the computer 200. The computer 200 may read the monitoring program 205a from any of these media and execute the monitoring program 205a.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. A non-transitory computer-readable recording medium storing a monitoring program that cause a computer to execute processes comprising:
determining a learning range, used in learning of messages, for each of monitoring target systems based on time-series information of each of past message groups and on keyword information that is obtained from contents of each of the messages and that suggests a forwarding destination of the message;
generating a learning model, used to infer information on the forwarding destination from the keyword information of an error message, for each of the monitoring target systems by using the determined learning range as a parameter and by using the time-series information, the information on the forwarding destination, and the keyword information included in each of the messages in the case where the message is the error message as training data; and
when the error message of a new system is obtained, selecting the learning model to be applied to the new system from the learning models of the monitoring target systems, based on a degree of similarity between the keyword information used in the learning of each of the monitoring target systems and the keyword information of the error message of the new system.

2. The non-transitory computer-readable recording medium according to claim 1, wherein
the determining the learning range includes
for each of the error messages included in the past message group of each of the monitoring target systems, searching a predetermined number of messages that have occurred before a time point at which the error message has occurred, calculating a co-occurrence relationship between words in a range including the error message and the searched error messages, further searching messages in the past direction to a message that does not include a word having the calculated co-occurrence relationship, and calculating the number of messages from the error message to a message one before the message that does not include the word having the calculated co-occurrence relationship, as the learning range, and
determining the learning range of the monitoring target system by using the learning ranges calculated for the respective error messages.

3. The non-transitory computer-readable recording medium according to claim 2, wherein
the determining the learning range includes determining the learning range of the monitoring target system by using any one of an average value, a median value, and a mode value of the learning ranges calculated for the respective error messages.

4. The non-transitory computer-readable recording medium according to claim 1, wherein
the selecting the learning model includes vectorizing the keyword information of each of the monitoring target systems by a predetermined vectorization method, vectorizing the keyword information of the error message of the new system by the vectorization method, calculating a degree of similarity between a keyword vector of each of the monitoring target systems and a keyword vector of the error message of the new system, and selecting the learning model of the monitoring target system having the highest degree of similarity as the learning model to be applied to the new system.

5. The non-transitory computer-readable recording medium according to claim 4, wherein
the keyword information of the error message of the new system is inputted into the selected learning model to infer the information on the forwarding destination of the error message, and the keyword information that has affected the inferred information on the forwarding destination and a degree of effect of the keyword information are inferred by using a predetermined algorithm for obtaining an effect of each of pieces of the keyword information on an inference result of the learning model.

6. The non-transitory computer-readable recording medium according to claim 5, wherein
the information on the forwarding destination of the error message, a degree of contribution of the information on the forwarding destination, the keyword information that has affected the information on the forwarding destination, and the degree of effect of the keyword information are displayed on a display unit.

7. A monitoring system comprising:
a memory; and
a processor coupled to the memory and configured to:
determine a learning range, used in learning of messages, for each of monitoring target systems based on time-series information of each of past message groups and on keyword information that is obtained from contents of each of the messages and that suggests a forwarding destination of the message;
generate a learning model, used to infer information on the forwarding destination from the keyword information of an error message, for each of the monitoring target systems by using the determined learning range as a parameter and by using the time-series information, the information on the forwarding destination, and the keyword information included in each of the messages in the case where the message is the error message as training data; and
when the error message of a new system is obtained, select the learning model to be applied to the new system from the learning models of the monitoring target systems, based on a degree of similarity between the keyword information used in the learning of each of the monitoring target systems and the keyword information of the error message of the new system.

8. A monitoring method comprising:
determining a learning range, used in learning of messages, for each of monitoring target systems based on time-series information of each of past message groups and on keyword information that is obtained from contents of each of the messages and that suggests a forwarding destination of the message;
generating a learning model, used to infer information on the forwarding destination from the keyword information of an error message, for each of the monitoring target systems by using the determined learning range as a parameter and by using the time-series information, the information on the forwarding destination, and the keyword information included in each of the messages in the case where the message is the error message as training data; and
when the error message of a new system is obtained, selecting the learning model to be applied to the new system from the learning models of the monitoring target systems, based on a degree of similarity between the keyword information used in the learning of each of the monitoring target systems and the keyword information of the error message of the new system.
